(19) United States
(12) Patent Application Publication
(10) Pub. No.: US 2013/0271988 A1
(43) Pub. Date: Oct. 17, 2013

(54) HEAT SINK AND LED LAMP USING THE SAME

(71) Applicants: CHU-KENG LIN, Chu-Nan (TW); SUNG-HSIANG YANG, Chu-Nan (TW); WEI-CHUN YEH, Chu-Nan (TW)

(72) Inventors: CHU-KENG LIN, Chu-Nan (TW); SUNG-HSIANG YANG, Chu-Nan (TW); WEI-CHUN YEH, Chu-Nan (TW)

(73) Assignee: FOXSEMICON INTEGRATED TECHNOLOGY, INC., Chu-Nan (TW)

(21) Appl. No.: 13/585,848

(22) Filed: Aug. 15, 2012

(30) Foreign Application Priority Data
Apr. 16, 2012 (TW) 101113384

(51) Int. Cl. F21V 29/00; F28F 7/00

(52) U.S. Cl. 362/249.02; 165/80.1

(57) ABSTRACT

An LED lamp includes a heat sink. The heat sink includes a base, a number of fins and two fixing elements for fixing the heat sink. The base includes a first face and a second face opposite to the first face. The fins extend from the first face of the base. The two fixing elements are detachably fixed on two ends of the base, respectively. Each fixing element includes a mounting plate, a fixing plate fixed on the first face of the base, and a connecting member connecting the fixing plate with the mounting plate.

### BACKGROUND

1. Technical Field

The disclosure relates to illuminating devices, and particularly to a light emitting diode (LED) lamp with a heat sink.

2. Description of Related Art

LED illumination lamps have been quickly developed in recent years. Compared with traditional illumination devices, the LED illumination lamps have small volume, short response time, long life, low driving voltage and better anti-shock capability.

A conventional LED lamp comprises a heat sink and a plurality of LED modules having LEDs attached to an outer surface of the heat sink. The heat sink dissipates heat generated by the LEDs. Two fixing elements used for fixing the LED lamp to a mounting bracket are integrally formed at two opposite ends of the heat sink. However, since the fixing elements are integrally formed with the heat sink as a single piece, the fixing elements can not be detached from the heat sink, and replaced by other fixing elements with required shapes and sizes.

What is needed, therefore, is a heat sink and an LED lamp using the same which can overcome the described limitations.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED lamp in accordance with a first embodiment of the disclosure.

FIG. 2 is a partially exploded view of the LED lamp of FIG. 1.

FIG. 3 is an inverted view of the LED lamp of FIG. 1.

FIG. 4 is an assembled, isometric view of an LED lamp in accordance with a second embodiment of the disclosure.

### DETAILED DESCRIPTION

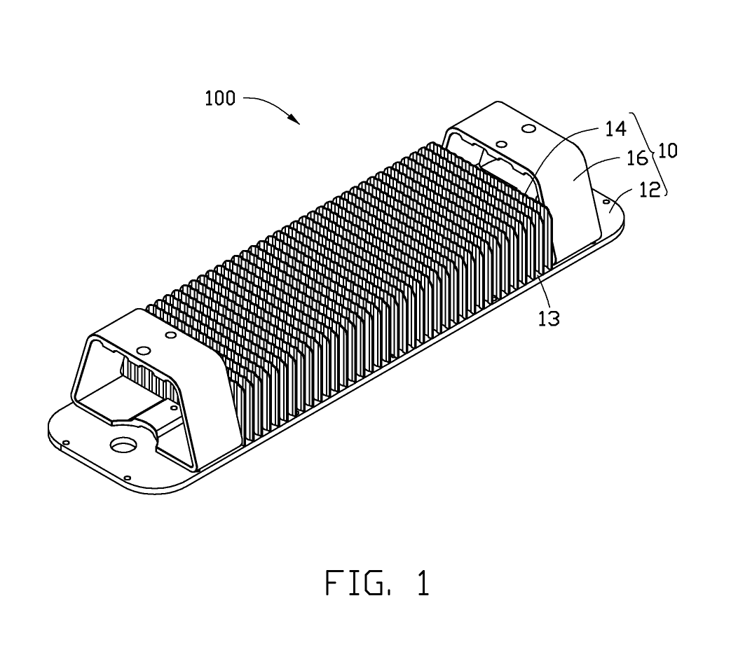

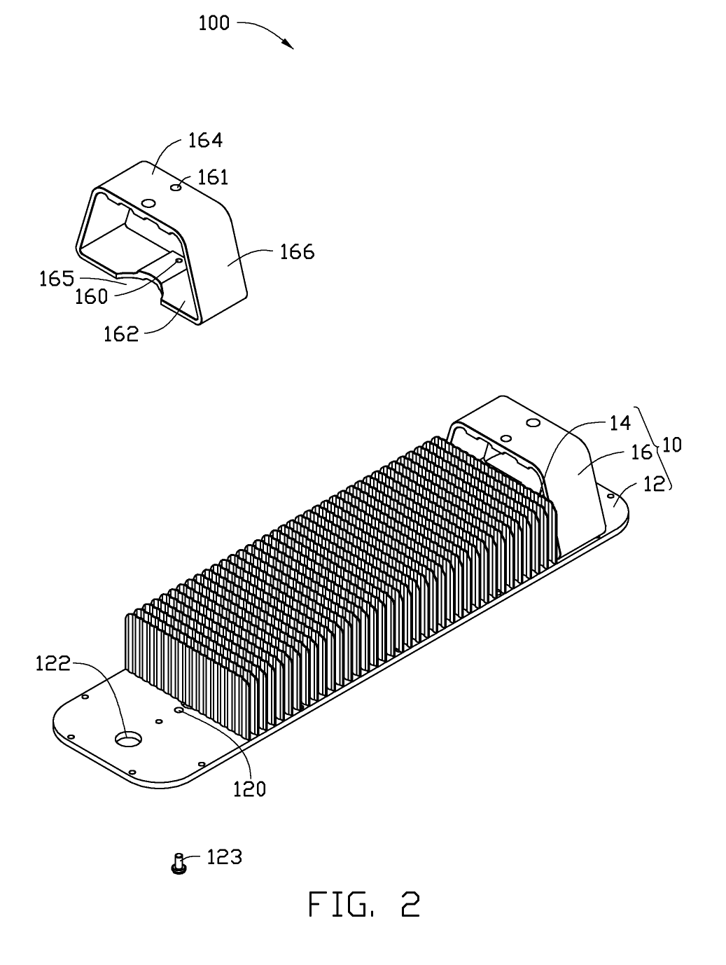

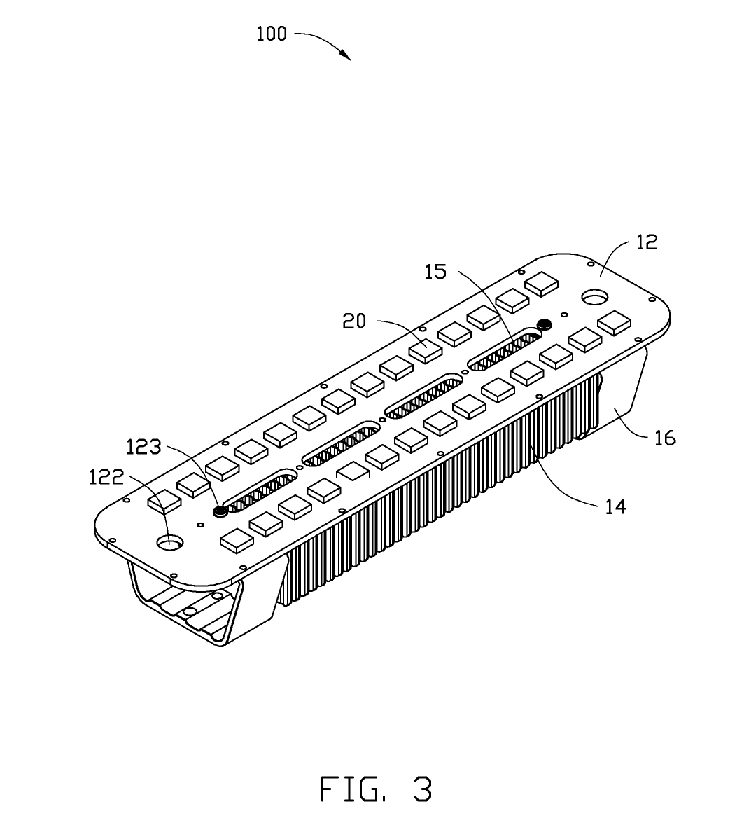

Referring to FIGS. 1-3, an LED lamp 100 in accordance with a first embodiment of the disclosure includes a heat sink 10, and a plurality of LEDs 20 attached to a bottom face of the heat sink 10.

The heat sink 10 is made of metal having a good thermal conductivity, such as aluminum, copper or an alloy thereof. The heat sink 10 includes a substantially rectangular plate-shaped base 12, a plurality of fins 14 vertically and upwardly extending from a top face of the base 12, and two fixing elements 16 detachably fixed on two opposite ends of the base 12, respectively. A cross section of each fin 14 parallel to the base 12 is wave-shaped. The fins 14 are spaced from each other and arranged along a length direction of the base 12. An airflow channel 13 is formed between every two adjacent fins 14.

The fixing elements 16 are used for fixing the LED lamp 100 to a mounting bracket (not shown). A cross section of each fixing element 16 perpendicular to the base 12 is a closed trapezoid. Each fixing element 16 includes a fixing plate 162 fixed on the top face of the base 12, a mounting plate 164 parallel to the fixing plate 162, and two plate-shaped connecting members 166 connecting the fixing plate 162 with the mounting plate 164. Two opposite edges of each connecting member 166 are connected to edges of the fixing plate 162 and the mounting plate 164, respectively. A length of the fixing plate 162 is longer than that of the mounting plate 164. Each connecting member 166 inclines towards an inner side of the fixing element 16 relative to the fixing plate 162. A fixing hole 160 is defined in the fixing plate 162. The mounting plate 164 defines two mounting holes 161 for extension of screws (not shown) therethrough to fix the LED lamp 100 to the mounting bracket.

The base 12 defines a fixing hole 120 and a through hole 122 in each end thereof. The fixing plate 162 defines a semicircular cutout 165 in a side near the through hole 122 of the base 12 for preventing an exterior element (not shown) engaging the through hole 122 from interfering with the fixing plate 162. A fastener 123 (a rivet, for example) extends through the fixing hole 120 of the base 12 and the fixing hole 160 of the fixing plate 162 to fix the fixing element 16 on the base 12. The base 12 defines four elongated through holes 15 in a center of the bottom face thereof. The elongated through holes 15 of the base 12 are arranged in a line along a length direction of the base 12 and communicate with the airflow channels 13 between the fins 14. The LEDs 20 are attached to the bottom face of the base 12 and located at two opposite sides of the elongated through holes 15.

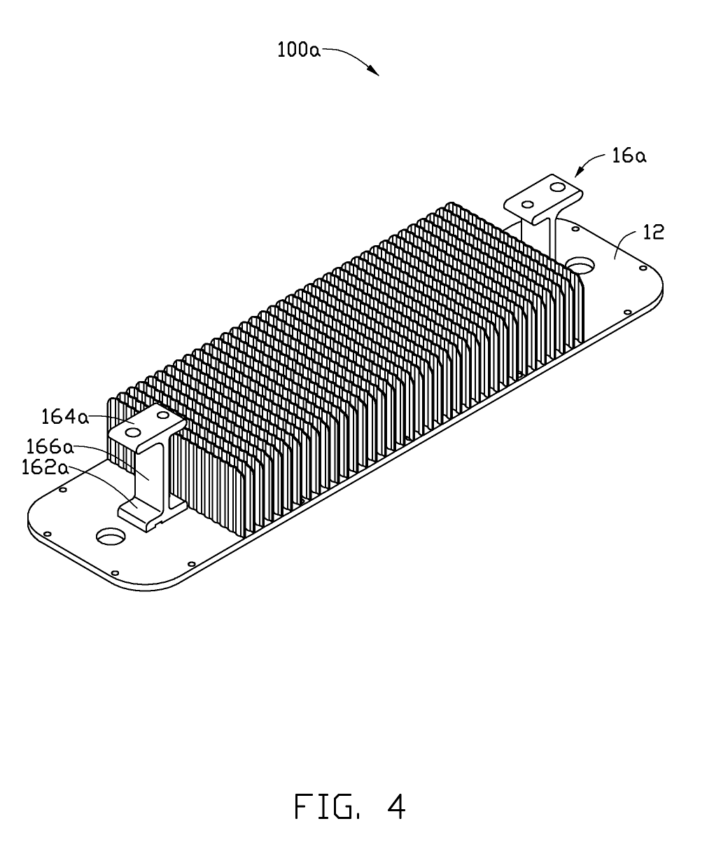

Referring to FIG. 4, an LED lamp 100a in accordance with a second embodiment of the disclosure is shown. The differences between the LED lamp 100a of the second embodiment and the LED lamp 100 of the first embodiment are in that: a cross sectional view of each fixing element 16a perpendicular to the base 12 is substantially I-shaped; each fixing element 16a includes a fixing plate 162a fixed on the top face of the base 12a, a mounting plate 164a parallel to the fixing plate 162a, and a plate-shaped connecting members 166a connecting the fixing plate 162a with the mounting plate 164a; the connecting members 166a is perpendicular to the fixing plate 162a and the mounting plate 164a; two opposite edges of the connecting members 166a are connected to centers of the fixing plate 162a and the mounting plate 164a, respectively.

According to the disclosure, the two fixing elements 16, 16a used for fixing the LED lamp 100, 100a are detachably fixed on the two opposite ends of the base 12. Thus, it is convenient to detach the fixing elements 16, 16a from the heat sink 10 and replace the fixing elements 16, 16a with other fixing elements with required shapes and sizes.

It is to be understood, however, that even though numerous characteristics and advantages of the present embodiments have been set forth in the foregoing description, together with details of the apparatus and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

1. A heat sink comprising:
a base comprising a first face and a second face opposite to the first face;
a plurality of fins extending from the first face of the base; and
two fixing elements for fixing the heat sink being detachably fixed on two ends of the base, each fixing element comprising a mounting plate, a fixing plate fixed on the first face of the base, and a connecting member connecting the fixing plate with the mounting plate.

2. The heat sink of claim 1, wherein a cross section of each fixing element perpendicular to the base is substantially I-shaped, the connecting members being perpendicular to the fixing plate and the mounting plate.

3. The heat sink of claim 1, wherein a cross section of each fin parallel to the base is wave-shaped.

4. The heat sink of claim 1, wherein a plurality of airflow channels are formed between adjacent fins, the base defining a plurality of elongated through holes in a center thereof, the elongated through holes of the base communicating with the airflow channels.

5. The heat sink of claim 4, wherein the elongated through holes of the base are arranged in a line along a length direction of the base.

6. The heat sink of claim 1, wherein each of the fixing elements further comprises another connecting member connected between the fixing plate and the mounting plate, two opposite edges of each of the connecting members being connected to edges of the fixing plate and the mounting plate, respectively.

7. The heat sink of claim 6, wherein a cross section of each of the fixing elements perpendicular to the base is a closed trapezoid, each of the connecting members inclining towards an inner side of the fixing element relative to the fixing plate.

8. The heat sink of claim 1, wherein each fixing plate defines a fixing hole, the base defining a fixing hole in each end thereof, a fastener extending through the fixing hole of the base and the fixing hole of the fixing plate to fix the fixing plate on the base.

9. An LED (light emitting diode) lamp comprising:
a plurality of LEDs; and
a heat sink comprising:
a base comprising a first face and a second face opposite to the first face, the LEDs being attached to the second face of the base;
a plurality of fins extending from the first face of the base; and
two fixing elements for fixing the heat sink being detachably fixed on two ends of the base, each fixing element comprising a mounting plate, a fixing plate fixed on the first face of the base, and a connecting member connecting the fixing plate with the mounting plate.

10. The LED lamp of claim 9, wherein a cross section of each fixing element perpendicular to the base is substantially I-shaped, the connecting members being perpendicular to the fixing plate and the mounting plate.

11. The LED lamp of claim 9, wherein a cross section of each fin parallel to the base is wave-shaped.

12. The LED lamp of claim 9, wherein a plurality of airflow channels are formed between adjacent fins, the base defining a plurality of elongated through holes in a center thereof, the elongated through holes of the base communicating with the airflow channels.

13. The LED lamp of claim 12, wherein the elongated through holes of the base are arranged in a line along a length direction of the base.

14. The LED lamp of claim 13, wherein the LEDs are located at two opposite sides of the elongated through holes of the base.

15. The LED lamp of claim 9, wherein each of the fixing elements further comprises another connecting member connected between the fixing plate and the mounting plate, two opposite edges of each of the connecting members being connected to edges of the fixing plate and the mounting plate, respectively.

16. The LED lamp of claim 15, wherein a cross section of each fixing element perpendicular to the base is a closed trapezoid, each of the connecting members inclining towards an inner side of the fixing element relative to the fixing plate.
